(19) United States
(12) Patent Application Publication
(10) Pub. No.: US 2021/0028806 A1
(43) Pub. Date: Jan. 28, 2021

(54) WATERPROOF CASE SUITABLE FOR MOBILE ELECTRONIC DEVICE

(71) Applicant: Pui Wah TSOI, Hong Kong (CN)

(72) Inventor: Pui Wah TSOI, Hong Kong (CN)

(21) Appl. No.: 16/630,736

(22) PCT Filed: Mar. 19, 2018
(86) PCT No.: PCT/CN2018/079454

§ 371 Date: Jan. 13, 2020

(51) Int. Cl. H04B 1/3888; H04B 1/3883; H04M 1/18

(52) U.S. Cl. CPC H04B 1/3888; H04B 2001/3894; H04M 1/18; H04B 1/3883

(57) ABSTRACT

The invention provides a waterproof case suitable for a mobile electronic device, which comprises a controller for controlling the mobile electronic device, a connector connected with the mobile electronic device and capable of transmitting data with the controller, and an input device for a user to input a command to the controller to control the mobile electronic device, wherein the input device comprises an operating portion and a first light sensing assembly capable of controlling operations on a control screen by reading displacement of the operating portion. According to the invention, the connector can be directly plugged into an interface of the mobile electronic device and signals can be transmitted using an open standard code without downloading client software. The invention is universal for different types of mobile electronic devices.

### TECHNICAL FIELD

The invention belongs to the field of electronic accessory technologies, and more particularly, to a waterproof case suitable for a mobile electronic device.

### BACKGROUND

With the improvement of people's living standard, diving has become a common healthy and leisure sport, and underwater photographing is often required while diving. However, professional diving photographing equipment is not only expensive, but also bulky and inconvenient to use. A waterproof case is emerged in the market at the right moment, which can load a mobile electronic device having a control screen and a camera, such as a mobile phone, etc. Some of these waterproof cases can take photos by a key installed on the waterproof case and capable of touching the mobile electronic device, but the waterproof case can only control a mobile phone with specific specification and key position, and the place where the key is arranged is easy to leak water, while some of these waterproof cases can take photos by controlling the mobile phone wirelessly through Bluetooth, but it is necessary to download client software for Bluetooth photographing on the mobile phone, which takes up a memory, has complicated steps, and is very inconvenient.

### SUMMARY

The invention is intended to provide a waterproof case suitable for a mobile electronic device and aims at solving the technical problem that the existing waterproof case of a mobile electronic device capable of taking photos is limited in use by a specification of the mobile electronic device or is inconvenient because of needing to download client software.

The invention is realized in the way that a waterproof case suitable for a mobile electronic device for carrying a mobile electronic device having a control screen and a camera comprises:

a case, wherein the case comprises a first case portion and a second case portion which can be covered with each other and detachably connected, the first case portion and the second case portion jointly form an accommodating cavity for placing the mobile electronic device in a covered state and isolated from the outside, and the case comprises a first visual window made of a transparent material and used for a user to observe the control screen, and a second visual window made of a transparent material and used for light to penetrate to enable the camera to acquire an image; and

a control assembly, wherein the control assembly is isolated from the outside and comprises a controller for controlling the mobile electronic device, a connector for electrically connecting the mobile electronic device and the controller, and an input device for a user to input a command to the controller, and the controller controls the mobile electronic device according to the command inputted by the input device.

Specifically, the connector is electrically connected with the controller by an electrical lead.

Specifically, the connector is wirelessly connected with the controller.

Specifically, the input device comprises at least one key, each of the keys is flexibly connected with the case, the controller comprises at least one push-type switch, and each of the push-type switches is arranged corresponding to one of the keys respectively.

Specifically, the input device further comprises an operating portion connected with the case and a first light sensing assembly electrically connected with the controller and capable of controlling operations on the control screen by reading a moving direction and a moving distance of the operating portion during a unit time.

Specifically, the input device further comprises an operating panel connected with the case, used for touching and made of a transparent material, and a second light sensing assembly located below the operating panel and capable of sensing a direction and a distance of a touch path during a unit time on the operating panel to control the operations on the control screen.

Specifically, the operating portion is a trackball structure, the trackball structure comprises a ball bracket connected with the case, provided with a positioning groove and capable of transmitting light, and a rotatable trackball located in the positioning groove, and an opening of the positioning groove is arranged outwardly.

Specifically, the waterproof case suitable for a mobile electronic device further comprises a charging device for charging the mobile electronic device.

Specifically, the charging device is electrically connected with the controller.

Specifically, the charging device comprises a wireless charging circuit capable of charging the mobile electronic device by electromagnetic induction.

Relative to the prior art, the invention has the following technical effects: according to the invention, data transmission between the controller and the mobile electronic device is realized by arranging the connector capable of being electrically connected with the mobile electronic device, and the command is inputted to the controller by the input device to control the mobile electronic device. Since the connector is electrically connected with the mobile electronic device directly, that is, the connector can be directly plugged into an interface of the mobile electronic device, an open standard code in a communication field can be used for signal transmission without downloading specific client software for signal matching, and the invention is universal for different types of mobile electronic devices. According to the invention, the inconvenience in control by using the key to directly touch the display screen of the mobile electronic device or the key of the mobile electronic device is avoided, the problem of water leakage that often occurs at a place where the key is arranged is solved, and the operation and control of the control assembly on the mobile electronic devices of different specifications and models are directly realized by the connector. The accommodating cavity and the control assembly are isolated from the outside. Therefore, the invention has a waterproof function.

### BRIEF DESCRIPTION OF THE DRAWINGS

In order to more clearly illustrate the technical solutions in the embodiments of the invention, the drawings to be used in the embodiments of the invention or the description of the prior art will be briefly introduced below. Obviously, the drawings in the following description merely indicate some embodiments of the invention, and those of ordinary skills in the art can further obtain other drawings according to these drawings without giving any creative work.

FIG. 1 is a stereoscopic structure diagram of a waterproof case suitable for a mobile electronic device provided by an embodiment of the invention;

FIG. 2 is a stereoscopic diagram of FIG. 1 from another perspective;

FIG. 3 is a partial exploded view of a waterproof case suitable for a mobile electronic device provided by an embodiment of the invention, wherein the connector is electrically connected with the controller by the electrical lead;

FIG. 4 is a further exploded view of FIG. 3;

FIG. 5 is a partial exploded view of a waterproof case suitable for a mobile electronic device provided by another embodiment of the invention, wherein the connector is wirelessly connected with the controller;

FIG. 6 is a structure diagram of a waterproof case suitable for a mobile electronic device provided by another embodiment of the invention, wherein the input device comprises an operating portion and a first light sensing assembly;

FIG. 7 is a partial exploded view of FIG. 6; and

FIG. 8 is a cross-section view of FIG. 7.

### REFERENCE NUMERALS

| | | | |
|---|---|---|---|
| 10 | Case | 30 | Controller |
| 101 | First cavity body | 31 | Connector |
| 102 | Second cavity body | 311 | Electrical lead |
| 11 | First case portion | 32 | Input device |
| 110 | First visual window | 321 | Key |
| 12 | Second case portion | 322 | Operating portion |
| 120 | Second visual window | 3220 | Positioning groove |
| 40 | Hinged structure | 3221 | Ball bracket |
| 50 | Charging device | 3222 | Trackball |
| 121 | Buckled structure | 323 | First light sensing assembly |
| 122 | Rubber support | 3231 | First light emitting source |
| 20 | Mobile electronic device | 3232 | First receiver |

### DETAILED DESCRIPTION

The embodiments of the invention will be described in detail hereinafter. Examples of the embodiments are shown in the accompanying drawings. The same or similar reference numerals throughout the drawings denote the same or similar elements or elements having the same or similar functions. The embodiments described below with reference to the accompanying drawings are exemplary and are intended to explain the invention, but should not be construed as limiting the invention.

In the description of the invention, it shall be understood that the orientation or position relation indicated by the terms “top”, “bottom”, “inside” and “outside”, etc., are based on the orientation or position relation shown in the drawings, which is only used for convenience of description of the invention and simplification of description instead of indicating or implying that the indicated device or element must have a specific orientation, and be constructed and operated in a specific orientation, and thus shall not be understood as a limitation to the invention.

Moreover, the terms “first”, “second”, “third” and “fourth” are used for descriptive purposes only and cannot be understood as indicating or implying relative importance, or implicitly indicating the number of technical features indicated thereby. Thus, the feature defined by “first,” “second,” “third,” and “fourth” may explicitly or implicitly include one or more of the features. In the description of the invention, the meaning of “multiple” is two or more than two, unless otherwise specifically defined.

In the invention, the terms “installation”, “connected”, “connection” and “fixation” should be understood in broad sense unless otherwise specified and defined. For example, they can be fixed connection, removable connection or integrated connection; can be mechanical connection or electrical connection; can be directly connected, can also be indirectly connected through an intermediate medium, and can be connected inside two components, or can be an interaction relation of two elements. The specific meaning of the above terms in the invention can be understood in a specific case by those skilled in the art.

In order to enable the objects, the technical solutions and the advantages of the invention to be more clearly understood, the invention is further described in detail below with reference to the drawings and the embodiments.

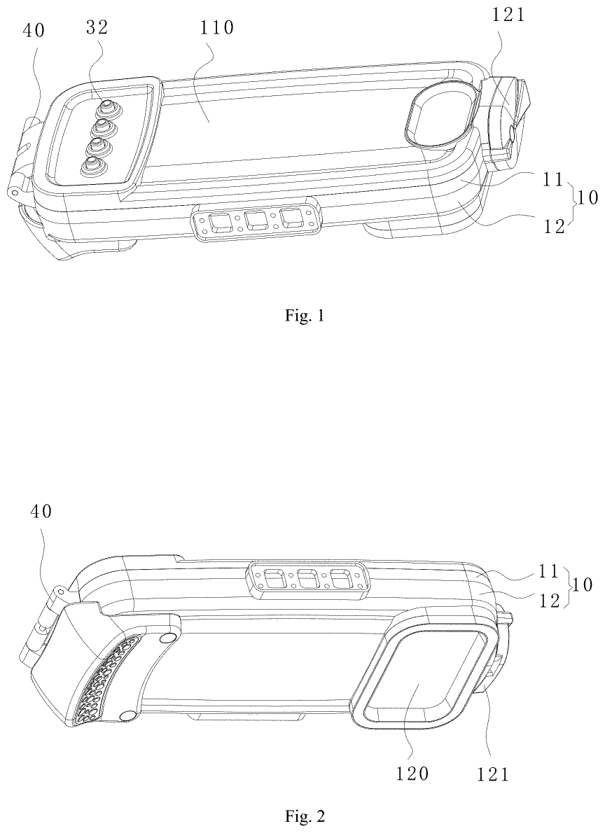

With reference to FIGS. 1 to 5, an embodiment of the invention provides a waterproof case suitable for a mobile electronic device 20 for carrying a mobile electronic device 20 having a control screen and a camera, which comprises:

a case 10, wherein the case 10 comprises a first case portion 11 and a second case portion 12 which can be covered with each other and detachably connected, the first case portion 11 and the second case portion 12 jointly form an accommodating cavity for placing the mobile electronic device 20 in a covered state and isolated from the outside, and the case 10 comprises a first visual window 110 made of a transparent material and used for a user to observe the control screen, and a second visual window 120 made of a transparent material and used for light to penetrate to enable the camera to acquire an image; and

a control assembly, wherein the control assembly is isolated from the outside and comprises a controller 30 for controlling the mobile electronic device 20, a connector 31 for electrically connecting the mobile electronic device 20 and the controller 30, and an input device 32 for a user to input a command to the controller 30, and the controller 30 controls the mobile electronic device 20 according to the command inputted by the input device 32.

According to the invention, data transmission between the controller 30 and the mobile electronic device 20 is realized by arranging the connector 31 capable of being electrically connected with the mobile electronic device 20, and the command is inputted to the controller 30 by the input device 32 to control the mobile electronic device 20. Since the connector is electrically connected with the mobile electronic device directly, that is, the connector can be directly plugged into an interface of the mobile electronic device, an open standard code in a communication field can be used for signal transmission without downloading specific client software for signal matching, and the invention is universal for different types of mobile electronic devices. According to the invention, the inconvenience in control by using the key to directly touch the display screen of the mobile electronic device 20 or the key of the mobile electronic device 20 is avoided, the problem of water leakage that often occurs at a place where the key is arranged is solved, and the operation and control of the control assembly on the mobile electronic devices 20 of different specifications and models are directly realized by the connector 31 without downloading client software. The accommodating cavity and the control assembly are isolated from the outside. Therefore, the invention has a waterproof function.

The mobile electronic device 20 may be a mobile phone, a tablet computer or other electronic devices with a virtual panel.

The connector 31 is used to realize data transmission between the mobile electronic device 20 and the controller 30, and the connector 31 can also be used to extend a USB interface accessory to an intelligent terminal, so as to enrich functions of the intelligent terminal. In the embodiment, the mobile electronic device 20 has an operating system based on a free and open source code of Linux, such as an Android system commonly used in the market, and the connector 31 is an OTG (On The Go) data connecting line.

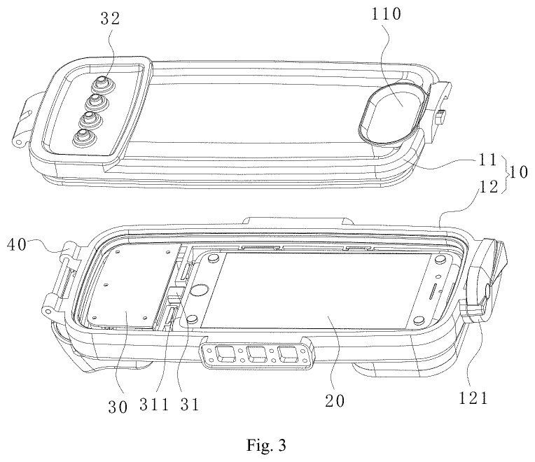

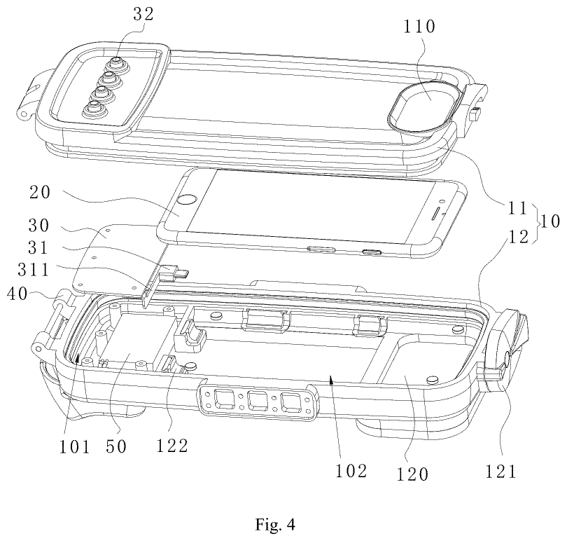

With reference to FIGS. 3 to 4, optionally, the invention provides an embodiment that the connector 31 is electrically connected with the controller 30 by an electrical lead 311. That is to say, the connector 31 transmits data derived from the controller 30 to the mobile electronic device 20 by the electrical lead 311. The connector 31 can be detachably connected with the controller 30, and the connector 31 having a plug matching with the interface can be replaced for the mobile electronic device 20 having different types of interfaces.

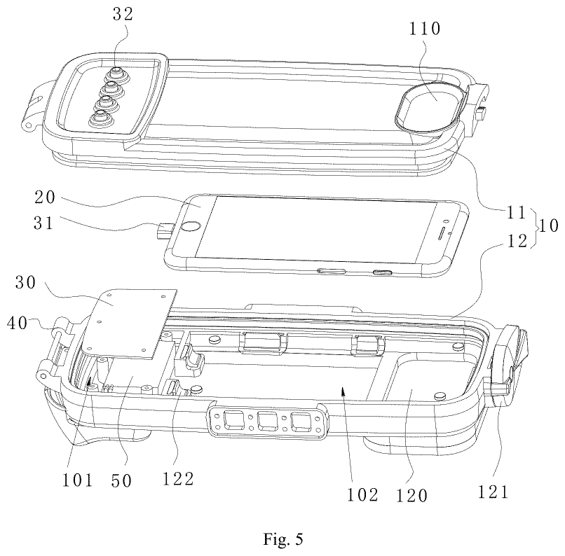

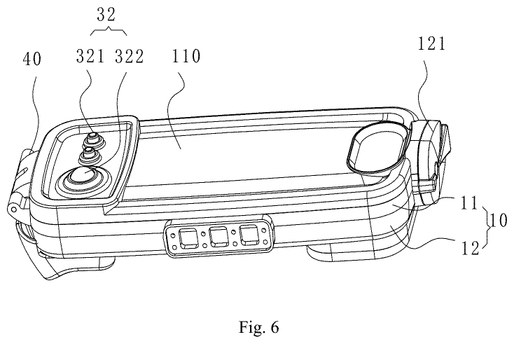

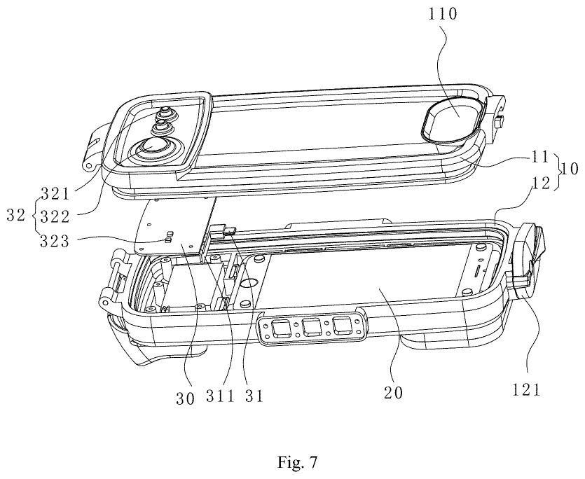

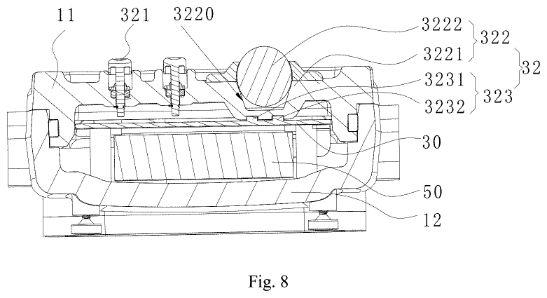

With reference to FIG. 5, optionally, the invention provides another embodiment that the connector 31 is wirelessly connected with the controller 30. That is to say, the connector 31 transmits data derived from the controller 30 to the mobile electronic device 20 wirelessly. Wireless connection between the connector 31 and the controller 30 saves a use space in the case, and prevents poor contact due to damage of the electrical lead 311 in a electrically connected state. The wireless transmission is performed by a RF radio wave or the like.

With reference to FIGS. 3 to 5, optionally, the input device 32 comprises at least one key 321, each of the keys 321 is flexibly connected with the case 10, the controller 30 comprises at least one push-type switch, and each of the push-type switches is arranged corresponding to one of the keys 321 respectively. The elastic connection refers to that when the key 321 is impacted by an external force, the key 321 moves towards the accommodating cavity, and the key 321 can automatically reset after the external force is removed. After the key 321 is impacted by the external force, the key 321 moves towards the accommodating cavity and finally abuts against the corresponding push-type switch, that is, the key 321 transmits an electrical signal by contact with the push-type switch, and the controller 30 controls the mobile electronic device 20 according to the command transmitted by the key 321.

With reference to FIGS. 3 to 5, preferably, the key 321 is flexibly connected with the first case portion 11 to facilitate a user to press.

An embodiment provided by the invention is that the input device 32 inputs the command by pressing the key 321, so that the controller 30 controls the control screen to switch the selective item confirm the selective item or exit the current operating interface.

Specifically, the input device 32 can comprise a first direction key for switching the selective item on the virtual panel of the control screen, a first determination key for determining the selective item selected by the first direction key, and a first return key for exiting the current operating interface.

In another embodiment provided by the invention, the difference from the embodiment above is that the controller 30 can enable a cursor to be displayed on the control screen, the input device 32 comprises a second direction key for controlling a displacement direction of the cursor and capable of moving a unit length by a single press, and the controller 30 controls displacement of the cursor by receiving the command outputted by pressing the second direction key. The key 321 further comprises a second determination key for determining the selective item pointed by the cursor and a second return key for exiting the current operating interface.

In another embodiment provided by the invention, the difference from the embodiment above is that the input device 32 comprises an operating portion 322 connected with the case 10 and a first light sensing assembly 323 electrically connected with the controller 31 and capable of controlling operations on the control screen by reading a moving direction and a moving distance of the operating portion 322 during a unit time. The controller 30 can enable a cursor to be displayed on the control screen; the controller 30 synchronously controls a moving direction and a moving distance of the cursor on the control screen during a unit time by receiving a position signal of the first light sensing assembly 323, and moves the cursor to a target position. The input device 32 further comprises a third determination key for determining the selective item pointed by the target position of the cursor and a third return key for exiting the current operating interface. In the embodiment, the first light sensing assembly 323 is arranged to read a displacement signal by light sensing, so as to control the cursor to move, and the operating portion 322 is not in direct contact with the first light sensing assembly 323, thus realizing sealing operation of the input device 32, effectively isolating from the outside, and avoiding water leakage that may be caused by a key-type structure.

Preferably, the operating portion is a trackball structure. The trackball structure comprises a ball bracket 3221 connected with the case 20 and provided with a positioning groove 3220, and a rotatable trackball 3222 located in the positioning groove, and an opening of the positioning groove 3220 is arranged outwardly. The trackball 3222 is isolated from the first light sensing assembly 323 by the ball bracket 3221, and the first light sensing assembly 323 can sense displacement of a local image generated by rotation of the trackball 3222 and calculate displacement data of an X-axis and a Y-axis, thus enabling the controller 30 to synchronously control displacement of the cursor on the control screen. The ball bracket 3221 and the case 10 form a sealed structure, and a user can control the cursor to move to a target position by rolling the trackball 3222 isolated from the outside, thus overcoming the technical problem that water leakage is easy to occur in a traditional key-type structure, and having faster and more accurate operation. Moreover, the trackball structure controls the mobile electronic device 20 by the controller and is not in direct contact with the control screen of the mobile electronic device, thus avoiding the inconvenience in operation by using the key to touch the screen, without matching with the key of the mobile electronic device or the target position on the control screen. Therefore, the invention is suitable for operation of the mobile electronic devices 20 of various models and types, and is universal.

The ball bracket 3221 has a light transmitting portion capable of transmitting light, the first light sensing assembly 323 comprises a first light emitting source 3231 and a first receiver 3232, light emitted by the first light emitting source 3231 is guided to a surface of the trackball 3222 by the light transmitting portion and reflected by the trackball 3222 to the first receiver 3232 through the light transmitting portion, and the light transmitting portion is located on a path of light emission and reflection.

The invention further provides an embodiment, and the difference from the embodiment above is that the input device 32 comprises an operating panel connected with the case, used for touching and made of a transparent material, and a second light sensing assembly 323 located below the operating panel and capable of sensing a direction and a distance of a touch path during a unit time on the operating panel to control the operations on the control screen. The operating panel and the case 10 form a sealed structure, a user moves a finger on the operating panel to enable the second light sensing assembly to sense displacement of the finger, thus calculating displacement data of an X-axis and a Y-axis, and enabling the controller 30 to synchronously control the displacement of the cursor on the control screen. The second light sensing assembly comprises a second light emitting source and a second receiver, and light emitted by the second light emitting source is guided to a surface of the operating panel by the operating panel and reflected by the finger to the second receiver through the operating panel. The input device 32 further comprises a fourth determination key for determining the selective item pointed by the cursor and a fourth return key for exiting the current operating interface. The effect of the embodiment is basically the same as that of the previous embodiment and will not be repeated here.

It shall be noted that a signal transmission mode of the input device 32 to the controller 30 is not limited to the description above, and correspondingly, an input mode of the input device 32 is not limited to the pressing of the key 321 and light sensing, but can also be other modes capable of realizing functions of selective item switching and selective item determination.

With reference to FIGS. 4 to 5, specifically, the waterproof case suitable for a mobile electronic device 20 further comprises a charging device 50 for charging the mobile electronic device 20, so as to prevent the mobile electronic device 20 from being unable to acquire an image due to insufficient power.

With reference to FIG. 3, specifically, the charging device 50 is electrically connected with the controller 30, and the controller 30 is electrically connected with the mobile electronic device 20. Therefore, the charging device 50 realizes the function of charging the mobile electronic device 20 during an image acquisition process of the mobile electronic device 20.

In other embodiments, the charging device 50 can be electrically connected with the mobile electronic device 20 by the connector 31 detachably connected with the controller 30, that is, the charging device 50 and the controller 30 share the connector 31. The connector 31 connected with the charging device 50 can also be connected with an external power source to realize a function of charging the charging device 50.

Specifically, the charging device 50 comprises a wireless charging circuit capable of charging the mobile electronic device 20 by electromagnetic induction, and the wireless charging circuit can be used as an electromagnetic induction transmitting terminal to charge the mobile electronic device 20.

With reference to FIGS. 1 to 2, specifically, the first case portion 11 is hinged with the second case portion 12 by a hinged structure 40, the first visual window 110 is arranged in the first case portion 11, and the second visual window 120 is arranged in the second case portion 12. The first case portion 11 is opened during use, the mobile electronic device 20 is put into the accommodating cavity, and the virtual panel of the mobile electronic device 20 faces the first visual window 110, so that a user can observe an operating process on the virtual panel by the first visual window 110. Specifically, the waterproof case suitable for a mobile electronic device 20 further comprises a buckled structure 121 for fixing free ends of the first case portion 11 and the second case portion 12 in a covered state.

Those described above are merely preferred embodiments of the invention, but are not intended to limit the invention. Any modifications, equivalent substitutions and improvements made without departing from the spirit and principle of the invention shall all fall within the protection scope of the invention.

1. A waterproof case suitable for a mobile electronic device for carrying a mobile electronic device having a control screen and a camera, comprising:
a case, wherein the case comprises a first case portion and a second case portion which can be covered with each other and detachably connected, the first case portion and the second case portion jointly form an accommodating cavity for placing the mobile electronic device in a covered state and isolated from the outside, and the case comprises a first visual window made of a transparent material and used for a user to observe the control screen, and a second visual window made of a transparent material and used for light to penetrate to enable the camera to acquire an image; and
a control assembly, wherein the control assembly is isolated from the outside and comprises a controller for controlling the mobile electronic device, a connector connected with the mobile electronic device and capable of transmitting data between the mobile electronic device and the controller, and an input device for a user to input a command to the controller, and the controller controls the mobile electronic device according to the command inputted by the input device.

2. The waterproof case suitable for a mobile electronic device according to claim 1, wherein the connector is electrically connected with the controller by an electrical lead.

3. The waterproof case suitable for a mobile electronic device according to claim 1, wherein the connector is wirelessly connected with the controller.

4. The waterproof case suitable for a mobile electronic device according to claim 1, wherein the input device comprises at least one key, each of the keys is flexibly connected with the case, the controller comprises at least one push-type switch, and each of the push-type switches is arranged corresponding to one of the keys respectively.

5. The waterproof case suitable for a mobile electronic device according to claim 4, wherein the input device further comprises an operating portion connected with the case and a first light sensing assembly electrically connected with the controller and capable of controlling operations on the control screen by reading a moving direction and a moving distance of the operating portion during a unit time.

6. The waterproof case suitable for a mobile electronic device according to claim 4, wherein the input device further comprises an operating panel connected with the case, used for touching and made of a transparent material, and a second light sensing assembly located below the operating panel and capable of sensing a direction and a distance of a touch path during a unit time on the operating panel to control the operations on the control screen.

7. The waterproof case suitable for a mobile electronic device according to claim 6, wherein the operating portion is a trackball structure, the trackball structure comprises a ball bracket connected with the case, provided with a positioning groove and capable of transmitting light, and a rotatable trackball located in the positioning groove, and an opening of the positioning groove is arranged outwardly.

8. The waterproof case suitable for a mobile electronic device according to claim 1, wherein the waterproof case suitable for a mobile electronic device further comprises a charging device for charging the mobile electronic device.

9. (canceled)

10. (canceled)

11. The waterproof case suitable for a mobile electronic device according to claim 2, wherein the waterproof case suitable for a mobile electronic device further comprises a charging device for charging the mobile electronic device.

12. The waterproof case suitable for a mobile electronic device according to claim 3, wherein the waterproof case suitable for a mobile electronic device further comprises a charging device for charging the mobile electronic device.

13. The waterproof case suitable for a mobile electronic device according to claim 4, wherein the waterproof case suitable for a mobile electronic device further comprises a charging device for charging the mobile electronic device.

14. The waterproof case suitable for a mobile electronic device according to claim 5, wherein the waterproof case suitable for a mobile electronic device further comprises a charging device for charging the mobile electronic device.

15. The waterproof case suitable for a mobile electronic device according to claim 6, wherein the waterproof case suitable for a mobile electronic device further comprises a charging device for charging the mobile electronic device.

16. The waterproof case suitable for a mobile electronic device according to claim 7, wherein the waterproof case suitable for a mobile electronic device further comprises a charging device for charging the mobile electronic device.

17. The waterproof case suitable for a mobile electronic device according to claim 8, wherein the charging device is electrically connected with the controller.

18. The waterproof case suitable for a mobile electronic device according to claim 8, wherein the charging device comprises a wireless charging circuit capable of charging the mobile electronic device by electromagnetic induction.
